(19) United States
(12) Patent Application Publication
(10) Pub. No.: US 2002/0020102 A1
(43) Pub. Date: Feb. 21, 2002

(54) Fish-luring aromatic and enticing article based on porous, thermoplastic plastic

(76) Inventor: Jurgen Beil, Bad Bramstedt (DE)

Correspondence Address: Kevin S. Lemack, Nields & Lemack, Suite 8, 176 E. Main Street, Westboro, MA, 01581, US

(21) Appl. No.: 09/918,074

(22) Filed: Jul. 30, 2001

(30) Foreign Application Priority Data
Aug. 21, 2000 (DE) 100 40 778.1

(51) Int. Cl. A01K 69/00; A01K 71/00; A01K 73/00

(52) U.S. Cl. 43/4.5

(57) ABSTRACT

A method for the production of aromatic and/or enticing baits, in which a material based on porous, thermoplastic plastic is treated with at least one fish-luring aromatic and/or enticing substance, as well as aromatic and/or enticing baits, is described.

### BACKGROUND OF THE INVENTION

The invention concerns a method for the production of aromatic and enticing baits based on porous, thermoplastic plastic, as well as corresponding aromatic and enticing baits and their use for luring fish.

Fish are lured by aromatic and enticing substances. For example, fish catch chances can be clearly increased in this way. This presumes that aromatic and enticing substances are released in a controlled manner, since the aromatic and luring effect depends on the quantity, i.e., the concentration of released aromatic and enticing substances in the vicinity.

Correspondingly, proposals for fish-luring aromatic and enticing baits, which will lead to the controlled release of aromatic and enticing substances, have not been lacking in the past. Nowadays, fish-luring aromatic and enticing substances are usually introduced onto conventional materials, particularly fish food or are mixed with these. It is further known to create optical baits (lures) comprised of conventional material in such a way that they act as an enticement for fish due to their color and/or shape. Enticing substances may also be introduced onto this bait.

Conventional fish-luring aromatic and enticing substances, however, on the one hand, have the disadvantage that their production is too expensive, and, on the other hand, that the respective aromatic and enticing substance is not released in a sufficiently uniform manner, since it is relatively quickly washed away, for example. The disadvantage of these enticing methods is thus, first of all, an aromatic or enticing effect that only lasts for a short time. On the other hand, larger quantities of fish food treated with aromatic and/or enticing substance, particularly in the case of stagnant waters, lead to an increased oxygen requirement of the waters, due to bacterial and chemical mineralization. The consequence is a limited living space for fish. For this reason, in many such waters, there is already a strict prohibition against fish food.

Consequently, the object of the invention is to make available a method for producing fish-luring aromatic and/or enticing articles. These aromatic and enticing articles will not have the above-named disadvantages.

It has now been found surprisingly that porous, thermoplastic plastics are not only suitable for uptake of substances, but also can release fish-luring aromatic and/or enticing articles, with which they have been treated.

For example, a porous, filled material can be used, which has been used for several decades as a battery separator in accumulators and batteries, as is described in detail in U.S. Pat. No. 3,351,495, and the corresponding DE-AS (Examined) 1,496,123. As is deduced further from DE-A1 196 16,224, the material is suitable for the absorptive control of unpleasant odors, which arise due to perspiration and other bodily exhalations. In contrast to this, it was surprising that the material is suitable not only as a battery separator material and for the absorption of unpleasant odors, but conversely, according to the invention, can take up, store, and release fish-luring aromatic and/or enticing substances, with which it is treated, and particularly that it can release aromatic and/or enticing substances in water in a controlled manner.

### SUMMARY OF THE INVENTION

The subject of the invention is correspondingly a method for the production of aromatic and/or enticing articles, in which a material based on porous, thermoplastic plastic is treated with at least one fish-luring aromatic and/or enticing substance.

In addition, the invention concerns aromatic and/or enticing articles, which contain or are comprised of a porous, thermoplastic plastic, which has been treated with at least one fish-luring aromatic and/or enticing substance.

Finally, the invention concerns the use of the aromatic and/or enticing articles according to the invention for luring fish.

### DETAILED DESCRIPTION OF THE INVENTION

The materials used according to the invention are porous and can have pores of up to an average pore size of 100 μm. However, pore sizes of up to 20 μm, i.e., materials with fine pores, are preferred. Preferably, the material has an average pore size of less than 3 μm, preferably less than 1 μm and particularly less than 0.5 μm pore diameter. Preferably, more than 50% of the pores possess a diameter of 0.5 μm or less. Materials with an average pore size in the range of 0.10 to 0.20 μm have proven particularly suitable. The void volume (porosity) of the plastic preferably amounts to at least 50% and particularly to at least 55%, for example, 57 to 65%. However, it may also amount to up to 70 or even 80%.

Various plastics of different molecular weight can be used. Polyvinyl chloride (PVC) and polyolefin are preferred. Porous, filled polyolefin, which consists of a homogeneous mixture of 8 to 100 vol. % polyolefin with a molecular weight (weight average) of at least 300,000, a standard-load melt index of substantially 0, measured according to ASTM-D-1278-57T (condition E), and a reduced viscosity of not less than 4.0, measured with a solution of 0.02 g of the polyolefin in 100 g of decalin at 130° C., 0 to 92 vol. % filler and 0 to 40 vol. % plasticizer.

As already mentioned, this material has already been known as a battery separator material for a long time and is described in detail in U.S. Pat. No. 3,351,495 and the corresponding DE-AS (examined) 1,496,123. The disclosure of these publications is herewith expressly incorporated by reference. The polyolefin involves ultra-high molecular weight polyolefin, preferably ultra-high molecular weight polyethylene. It has a weight-average molecular weight of at least 300,000, preferably at least 1,000,000 and in particular 4 to 7×10⁶. The standard load-melt index of the polyolefin is substantially 0, i.e., it is less than 0.1 and preferably less than 0.01. Preferably, the high-load melt index is less than 3, and particularly less than 2, and more particularly 1.8 or less than 1.8. The reduced viscosity of the polyolefin does not amount to less than 4.0 and preferably is more than 10 and particularly more than 15. With respect to the determination of standard-load or high-load melt index and reduced viscosity, reference is made to the above-named U.S. Pat. No. 3,351,495 or DE-AS (examined) 1,496,123. As explained in these publications, polyolefin mixtures may also be used. In addition to polyethylene in particular, polypropylene, polybutene, polystyrene, ethylene/propylene copolymers, ethylene/hexylene copolymers, ethylene/butene copolymers, propylene/butene copolymers, ethylene/propylene/butene copolymers and copolymers of ethylene or propylene with an ethylenically unsaturated monocarboxylic acid, for example, acrylic acid, methacrylic acid, or mixtures thereof, are suitable.

Suitable fillers and plasticizers are known to the expert. In this context, reference is made again to U.S. Pat. No. 3,351,495 and DE-AS (examined) 1,496,123. A preferred filler is finely divided silica (silicic acid). The average particle size (diameter) of the filler is in the range from 0.01 to 20 μm, the surface of the filler being in the range from 30 to 950 m²/g and preferably at least 100 m²/g. The material to be used as a plasticizer in a particularly preferred manner according to the invention comprises a water-insoluble oil, particularly process oil. Preferred ranges of amounts for the homogeneous mixture are 15 to 60 vol. % polyolefin, particularly 30 to 45 vol. % polyolefin, 35 to 80 vol. % filler, particularly 50 to 65 vol. % filler, and 1 to 7 vol. % plasticizer.

The materials that can be used according to the invention that are based on porous PVC are described, among others, by W. Böhnstedt in the section “Separators” in “Handbook of Battery Materials” (J. O. Besenhard, editor, VCH Weinheim, 1999, pp. 245-292). They can be produced according to sintering or extrusion processes.

In addition to the constituents mentioned, the material to be used according to the invention can comprise customary additives, such as antioxidants (usually 0.1 to 1%), lubricant (usually 0.1 to 1%), antistatics, pigments, dyestuffs, carbon black, stabilizers, light stabilizers, wetting agents and the like.

The material based on porous polyolefin is preferably produced in the way described in U.S. Pat. No. 3,351,495 or DE-AS (examined) 1,496,123, particularly by extrusion and subsequent extraction of filler and/or plasticizers (see also EP 0 425,784 B1). It is preferable here that the material is extruded in the form of a web, from which the desired shapes are then cut out. The above-mentioned publications are referred to in respect of the details of the extrusion, the extraction and the porosity which can be influenced by these.

When the material to be used according to the invention is present in the form of a web, the thickness amounts to 0.025 to 1.5 mm and preferably 0.2 to 1.2 mm (e.g., approximately 1.0 mm).

The treatment of the material with fish-luring aromatic and/or enticing substance may be carried out following the extraction of the material web or, however, after cutting out or producing the desired shapes from the material web. Preferably, the treatment with aromatic and/or enticing substance is made, however, on the finished product, which was produced from the porous plastic or with its use in a material.

As has already been mentioned, the aromatic and/or enticing articles according to the invention are suitable for a multiple number of applications for luring fish. Preferably, however, the invention concerns the release of aromatic and/or enticing substances in or under water, for example, in the sea, in lakes and rivers, but also in aquariums.

A wide assortment of suitable aromatic and/or enticing substances, which can find use in the method according to the invention, are available on the market, e.g., salmon roe aroma, cheese aroma, peanut aroma, coconut aroma, almond aroma, cheese, aroma, pistachio aroma, fruit aromas (strawberry, raspberry, cherry, banana, melon, peach), chocolate aroma, cream aroma, honey aroma and caramel aroma, salmon roe oil as well as extracts of anise, cinnamon and vanilla. The aromatic and/or enticing substances utilized are thus selected with respect to the fish species to be lured, since different fish species respond frequently to different aromatic and/or enticing substances.

Liquid or dissolved fish-luring aromatic and/or enticing substances or formulations can be used, as well as dispersions, such as emulsions, for example. Of course, mixtures of two or more aromatic and/or enticing substances may also be used. Preferably, liquid aromatic and/or enticing substances are used (i.e., without solvent constituent), with which the material is sprayed or with which it is impregnated. If the aromatic and/or enticing substances have a liquid constituent (i.e., they are present dissolved in a solvent), then after the treatment of the material with aromatic and/or enticing substances and before use for luring fish according to the invention, the material is usually dried.

Prior to its treatment with aromatic and/or enticing substances, the material can be glued, welded, heat-shaped and/or printed under vacuum or under pressure, in order to change the shape desired for the application and the desired external appearance (for example, the color of the material or the aromatic and/or enticing article).

Fish-luring aromatic and/or enticing articles according to the invention can be present, for example, in the form of feed baskets, buoyant blocks for fish-catching nets, twisters and other fish-catching devices. The shapes themselves are known, but materials based on porous plastic were not previously utilized. Thus the external appearance, i.e., color, shape, etc., is preferably selected in such a way that the enticing effect is not hindered, but is promoted.

An enticing article need not be fully comprised of the material utilized according to the invention; it can also be coated with the material and may be present, for example, in the form of basic lead sheathings, blinker casings and spinner casings.

The method according to the invention offers a number of advantages. It is simple to conduct, since the aromatic and/or enticing substances are taken up and stored in a simple manner by the material, due to the porous structure of the material, but on the other hand, they can be released in a controlled manner.

The aromatic and/or enticing baits according to the invention are re-usable, which is particularly of importance in the case of commercial fishing. For example, if the aromatic and/or enticing substances are washed out from the baits after extended use according to the invention, after drying, the aromatic and/or enticing baits according to the invention can be treated again with the aromatic and/or enticing substances and re-used. In addition, the above-described undesired eutrophication, particularly of stagnant waters, is avoided.

In addition, the aromatic and/or enticing baits according to the invention can be used advantageously in aquariums, in which it is particularly important for aesthetic reasons not to use finely-divided fish food, since finely-divided fish food, as is known, leads to turbidity of the water in aquariums. For example, feed baskets, which have been treated with aromatic and/or enticing substance according to the invention, can contain relatively large-particle feed, whereby a hygienic and optically pleasing maintenance of living organisms, particular fish in aquariums, is made possible according to the invention.

The above-described material based on porous polyolefin rapidly takes up liquids up to its void volume of approximately 60%, due to its good wettability, the high void volume, its polymeric matrix and the hydrophilic filler. Depending on the consistency of the aromatic and/or enticing substances, and to a lesser extent also as a function of their water solubility, their regulated release in water takes place.

### EXAMPLE

A web-form material was produced by extrusion and subsequent extraction, as described in U.S. Pat. No. 3,351,495 and DE-AS (examined) 1,496,123. The obtained product consisted of 51 vol. % silica, 40 vol. % ultra-high molecular weight polyethylene with an average molecular weight of 5.6×10⁶, 2.5 vol. % carbon black (filler), and 0.5 vol. % antioxidant. The remainder of plasticizer (process oil) amounted to 6 vol. %.

The average pore size of the thus-produced products was determined by mercury porosimetry at 0.15 μm. The void volume (porosity) was approximately 60%.

Parts were cut out of this web-shaped material, and feed baskets were manufactured from these parts, and the feed baskets were impregnated with various liquid enticing substances. The enticing baits according to the invention were released into the water, each time depending on the consistency and water solubility of the enticing substances, with use by fishermen, whereby fish in the respective waters were lured. A good catch was observed with this bait. Even after fishing times of five hours, the smell of various enticing substances still was noticeable.

What is claimed is:

1. Method for producing aromatic and/or enticing articles and parts thereof, comprising treating a material based on porous, thermoplastic plastic with at least one fish-luring aromatic and/or enticing substance.

2. Method according to claim 1, in which said material has an average pore size of less than 20 μm pore diameter.

3. Method according to claim 1, in which said material has an average pore size less than 3 μm pore diameter.

4. Method according to claim 1, in which said material has an average pore size less than 1.0 μm pore diameter.

5. Method according to claim 1 or 2, in which more than 50% of the pores of the material have a diameter of 0.5 μm or less.

6. Method according to claims 1 or 2, in which the void volume of the material is at least 50%.

7. Method according to claim 1 or 2, in which the plastic is selected from the group consisting of polyvinyl chloride and polyolefin.

8. Method according to claim 7, in which said material is comprised of 8 to 100 vol. % polyolefin with a molecular weight (weight average) of at least 300,000, a standard-load melt index of substantitally 0, measured in accordance with ASTM-D-1278-57T (condition E), and a reduced viscosity of not less than 4.0, measured with a solution of 0.02 g of the polyolefin in 100 g of decalin at 130° C., 0 to 92 vol. % filler and 0 to 40 vol. % plasticizer.

9. Method according to claim 8, in which said material is comprised of 15 to 60 vol. % polyolefin, 35 to 80 vol. % filler and 1 to 7 vol. % plasticizer.

10. Method according to claim 8, in which the polyolefin is ultra-high molecular weight polyethylene.

11. Method according to claims 8, wherein said filler is finely-divided silica.

12. Method according to claims 8, in which said plasticizer is process oil.

13. Method according to claim 1, further comprising adhering, welding, heat-shaping and/or printing said material before it is treated with said fish-luring aromatic and/or enticing substance.

14. Aromatic and/or enticing articles, comprising a porous, thermoplastic plastic treated with at least one fish-luring aromatic and/or enticing substance.

15. The aromatic and/or enticing articles of claim 14, wherein said plastic has an average pore size of less than 20 μm pore diameter.

16. The aromatic and/or enticing articles of claim 14, wherein said plastic is selected from the group consisting of polyvinyl chloride and polyolefin.

17. The aromatic and/or enticing baits of claim 14, wherein said plastic is in the form selected from the group consisting of fish-catching devices, feed baskets, buoyancy blocks for fish-catching nets, basic lead sheathings, blinker casings, spinner casings, twisters and parts thereof.

18. Method of luring fish, comprising placing a porous, thermoplastic treated with least one fish-luring aromatic and/or enticing substance in a body of water containing fish.
